(19) United States
(12) Patent Application Publication
(10) Pub. No.: US 2016/0124602 A1
(43) Pub. Date: May 5, 2016

(54) ELECTRONIC DEVICE AND MOUSE SIMULATION METHOD

(71) Applicant: CHIUN MAI COMMUNICATION SYSTEMS, INC., New Taipei (TW)

(72) Inventor: HOW-WEN CHIEN, New Taipei (TW)

(21) Appl. No.: 14/843,333

(22) Filed: Sep. 2, 2015

(30) Foreign Application Priority Data
Oct. 29, 2014 (CN) 201410594774.1

(51) Int. Cl. G06F 3/0488; G06T 7/00; G06F 3/041; H04N 5/232

(52) U.S. Cl. CPC G06F 3/0488; H04N 5/23229; G06T 7/0042; G06F 3/0416; G06T 2207/10004

(57) ABSTRACT

In a mouse simulation method executed by an electronic device which connects to a computing device, a virtual mouse corresponding to at least one touch area is set. Images are captured at predetermined time intervals using a camera module of the electronic device. Two consecutive images are acquired from the captured images. Movement information of the electronic device is calculated by comparing the two consecutive images. A cursor which is displayed on a display device of the computing device is moved according to the movement information of the electronic device. The cursor is controlled to execute one or more operations when one or more touch signals are detected from the at least one touch area.

### CROSS-REFERENCE TO RELATED APPLICATIONS

This application claims priority to Chinese Patent Application No. 201410594774.1 filed on Oct. 29, 2014 in the China Intellectual Property Office, the contents of which are incorporated by reference herein.

### FIELD

The subject matter herein generally relates to simulation technology, and particularly to an electronic device and a mouse simulation method.

### BACKGROUND

A user may need to use a computing device without a mouse when they are away from the office. Manipulation of the cursor exactly without a mouse is difficult.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one example embodiment of an electronic device.

FIG. 2 is a flowchart of one example embodiment of a mouse simulation method.

FIG. 3 is a diagrammatic view of one example embodiment of a setting interface for setting properties of a virtual mouse.

FIG. 4 is a diagrammatic view of one example embodiment of a virtual mouse.

FIG. 5 is a diagrammatic view of one example embodiment of a first image.

FIG. 6 is a diagrammatic view of one example embodiment of a second image.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The present disclosure, including the accompanying drawings, is illustrated by way of examples and not by way of limitation. It should be noted that references to “an” or “one” embodiment in this disclosure are not necessarily to the same embodiment, and such references mean “at least one”.

The term “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

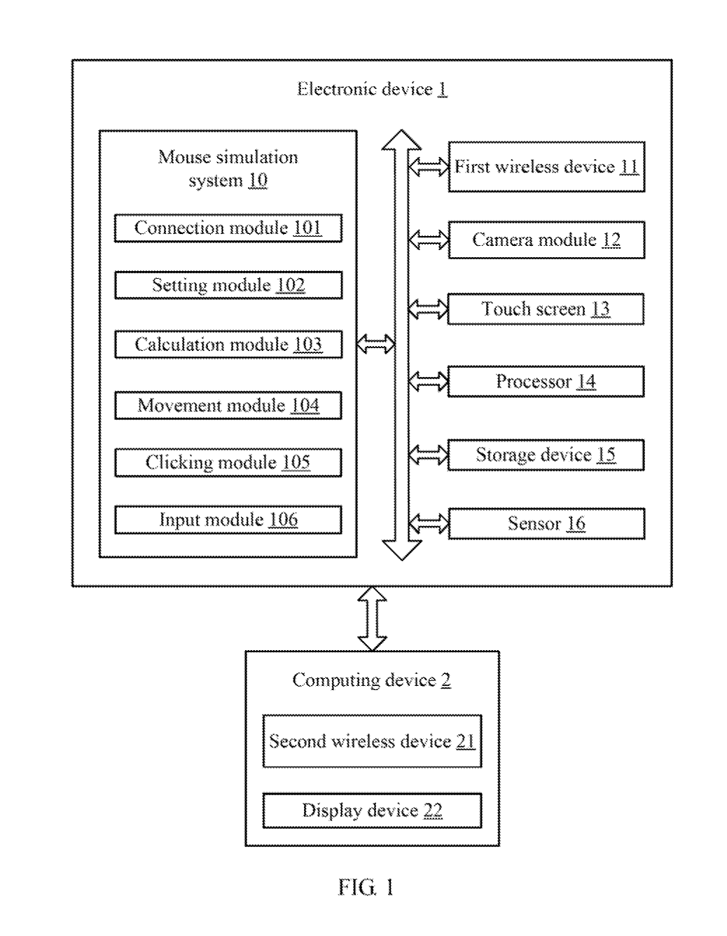

FIG. 1 is a block diagram of one example embodiment of an electronic device. In one embodiment as shown in FIG. 1, an electronic device 1 includes a mouse simulation system 10 and a first wireless device 11. The electronic device 1 communicates with a computing device 2 wirelessly. The computing device 2 includes a second wireless device 21. The electronic device 1 is connected to the computing device 2 through the first wireless device 11 and the second wireless device 21. The first wireless device 11 and the second wireless device 21 can be, but are not limited to, Bluetooth devices, wireless adapters or any other wireless communication devices.

The electronic device 1 further includes, but is not limited to, a camera module 12, a touch screen 13, at least one processor 14, a storage device 15, and a sensor 16. The computing device 2 further includes, but is not limited to, a display device 22. The electronic device 1 can be a mobile phone, a personal digital assistant (PDA), or any other suitable electronic device. The computing device 2 can be a computer, a notebook computer or any other device which includes a display device.

The camera module 12 can be a front-facing camera. The touch screen 13 can be touch panels, which support multi-touch, such as resistive touch screens or capacitive touch screens. In at least one embodiment, the at least one processor 14 can be a central processing unit (CPU), a microprocessor, or other data processor chip that performs functions of the electronic device 1. The storage device 15 can include various type(s) of non-transitory computer-readable storage medium. For example, the storage device 15 can be an internal storage system, such as a flash memory, a random access memory (RAM) for temporary storage of information, and/or a read-only memory (ROM) for permanent storage of information. The storage device 15 can also be an external storage system, such as a hard disk, a storage card, or a data storage medium. The sensor 16 is used to detect a rotation angle of the electronic device 1, such as a gyroscope.

The mouse simulation system 10 captures images at predetermined time intervals using the camera module 12, calculates movement information of the electronic device 1 based on analyses of the captured images, and controls movements of a cursor displayed on the display device 22 of the computing device 2. The mouse simulation system 10 can also detect one or more touch signals on at least one predetermined touch areas on the touch screen 13, and send a command to the computing device 2 according to the one or more touch signals.

In at least one embodiment, the mouse simulation system 10 can include a connection module 101, a setting module 102, a calculation module 103, a movement module 104, a clicking module 105, and an input module 106. The function modules 101-106 can include computerized codes in the form of one or more programs, which are stored in the storage device 15. The at least one processor 14 executes the computerized codes to provide functions of the function modules 101-106.

The connection module 101 can connect the electronic device 1 to the computing device 2 through the first wireless device 11 and the second wireless device 21. In at least one embodiment, the first wireless device 11 and the second wireless device 21 are Bluetooth devices.

The setting module 102 can set a virtual mouse by designating at least one touch area of the touch screen 13 through a setting interface. The at least one touch area includes a virtual left mouse button corresponding to a first touch area of the touch screen, a virtual right mouse button corresponding to a second touch area of the touch screen, a virtual mouse wheel corresponding to a third touch area of the touch screen. The setting module 102 also sets a precision of the virtual mouse and a background of the virtual mouse. The precision of the virtual mouse represents a ratio between a movement distance of the electronic device 1 and pixels of the cursor that moves on the display device 22. The movement distance of the electronic device 1 may be pixel distance. For example, when the precision of the virtual mouse is S, it means that the cursor moves S pixels when the electronic device 1 moves per unit pixel (the unit pixel can be 10 pixels, for example). The setting module 102 also displays the virtual mouse on the touch screen 13.

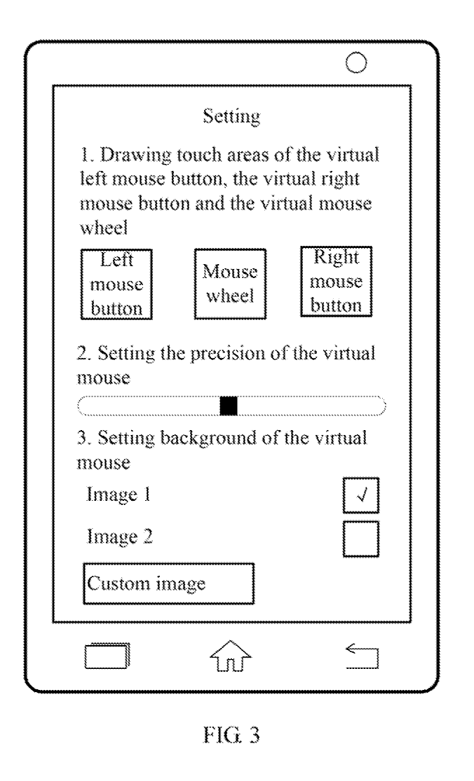

FIG. 3 is a diagrammatic view of one example embodiment of a setting interface for setting a virtual mouse. In at least one embodiment, the setting interface can be invoked when a predetermined signal is detected on the touch screen 13. In some embodiments, the predetermined signal can be detected when a predetermined touch operation (e.g. two-finger scroll down) is executed or a preset button (e.g. a virtual button or a physical button) is pressed.

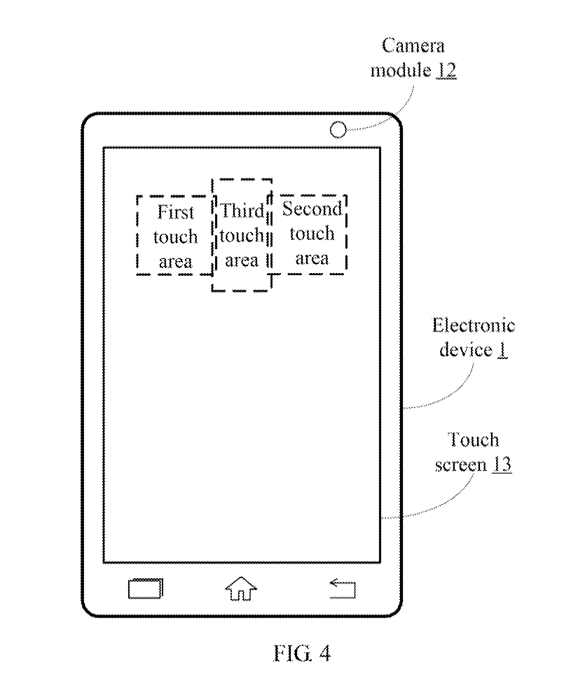

FIG. 4 is a diagrammatic view of one example embodiment of the virtual mouse. The setting module 102 displays the virtual mouse on the touch screen 13.

The calculation module 103 can capture images at predetermined time intervals using the camera module 12, and calculates movement information of the electronic device 1 according to the captured images. In at least one embodiment, the calculation module 103 acquires two consecutive images, which include a first image and a second image, from the captured images. The calculation module 103 further calculates movement information of the electronic device 1 by comparing the first image and the second image.

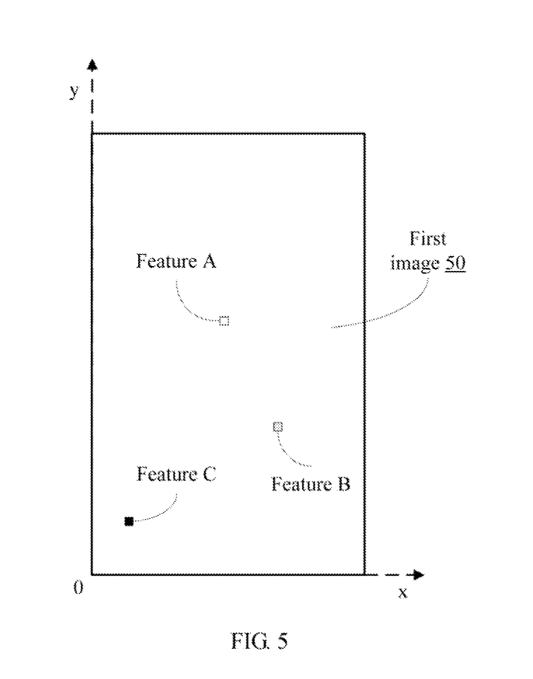

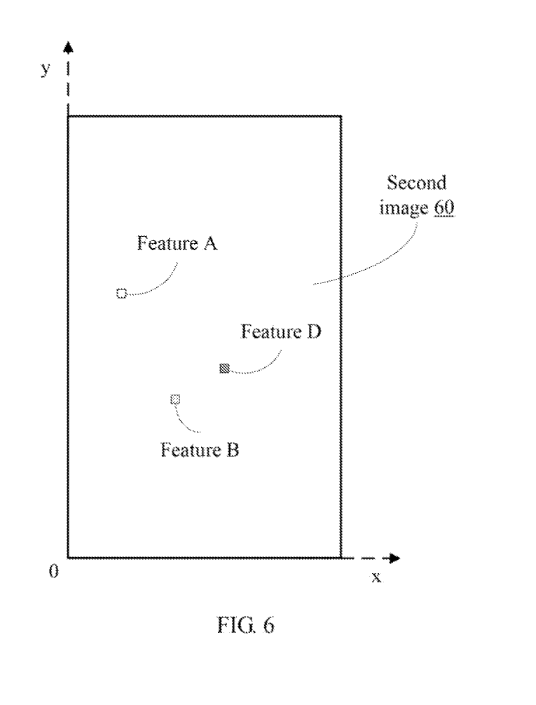

The calculation module 103 extracts at least one specified feature in both of the first image and the second image, and calculates the movement information of the electronic device 1 by calculating movement information of the specified feature. In some embodiments, the specified feature can be represented by dots in a two-dimensional Cartesian coordinate system as shown in FIG. 5 and FIG. 6. The calculation module 103 calculates the movement information of the specified feature according to changes of coordinates of the specified feature. When the calculation module 103 cannot extract any specified feature in both of the first image and the second image, that is, the first image and the second image have no same features, the calculation module 103 indicates a user in a default manner (e.g., outputting an audio prompt or a text prompt) to move the electronic device 1 to capture new images.

FIG. 5 is a diagrammatic view of one example embodiment of the first image. FIG. 6 is a diagrammatic view of one example embodiment of the second image. As shown in FIG. 5, when a first image 50 is captured, the calculation module 103 extracts three features (A, B and C). The calculation module 103 also determines coordinates of the three features. When a second image 60 is captured, the calculation module 103 searches the second image 60. As shown in FIG. 6, the calculation module 103 merely identifies the features A and B in the second image, and then extracts coordinates of the features A and B. Accordingly, the features A and B are determined to be the specified features which are both in the first image 50 and the second image 60. The calculation module 103 calculates the movement information of the electronic device 1 according to the movement information of the features A and B. In one embodiment, the calculation module 103 also can extract a feature D from the second image 60 to make sure that the calculation module 103 can also search for three features A, B and D in a third image.

In at least one embodiment, the calculation module 103 can calculate the movement information of the electronic device 1 by determining one specified feature that is closest to a center of the first image 50, and calculating the movement information of the specified feature that is closest to the center of the first image 50. FIG. 6 illustrates the features of the first image which can be detected from the second image are feature A and feature B. FIG. 5 illustrates the feature A is the specified feature that is closer to the center of the first image 50. Thus, the calculation module 103 calculates the movement information of the electronic device 1 according to the movement information of the feature A. In at least one embodiment, the calculation module 103 can record the movement information of the electronic device 1 in pixels.

The movement module 104 moves a cursor displayed the display device 22 of the computing device 2 according to the movement information of the electronic device 1. The movement module 104 first determines the movement information of the cursor according to the movement information of the electronic device 1 and the precision of the virtual mouse. Then the movement module 104 moves the cursor displayed on the display device 22 of the computing device 2 according to the movement information of the cursor.

The calculation module 103 can further determine whether the captured images are mirror images. In one embodiment, when the captured images are mirror images, the feature A is moved upwards in X pixels, and moved leftwards in Y pixels, the calculation module 103 determines that the electronic device 1 moves downwards in X pixels, and moves rightwards in Y pixels. And the movement module 104 determines that the cursor moves downwards in X*S pixels, and moves rightwards in Y*S pixels. When the captured images are not mirror images, the feature A is moved upwards in X pixels, and moved leftwards in Y pixels, the calculation module 103 determines that the electronic device 1 moves downwards in X pixels, and moves leftwards in Y pixels. And the movement module 104 determines that the cursor moves downwards in X*S pixels, and moves leftwards in Y*S pixels.

The clicking module 105 detects one or more touch signals on the at least one touch area of the touch screen, and controls the cursor on the display device 22 to execute one or more operations by sending a command to the computing device 2 according to the one or more touch signals. The clicking module 105 determines an operation of a user according to the one or more touch signals, and sends a command to the computing device 2 according to the operation. The operation of the user can be, but is not limited to a left click, a right click, a double left click, a double right click, a scroll up or a scroll down.

In other embodiments, the input module 106 can display a virtual keyboard on the touch screen 13 when a predetermined invoking signal is detected. In at least one embodiment, the predetermined invoking signal is triggered when the electronic device 1 rotates more than a preset angle within a time interval. The input module 106 detects a rotated angle using the sensor 16, and displays a virtual key board on the touch screen 13 when the rotated angle is greater than the preset angle.

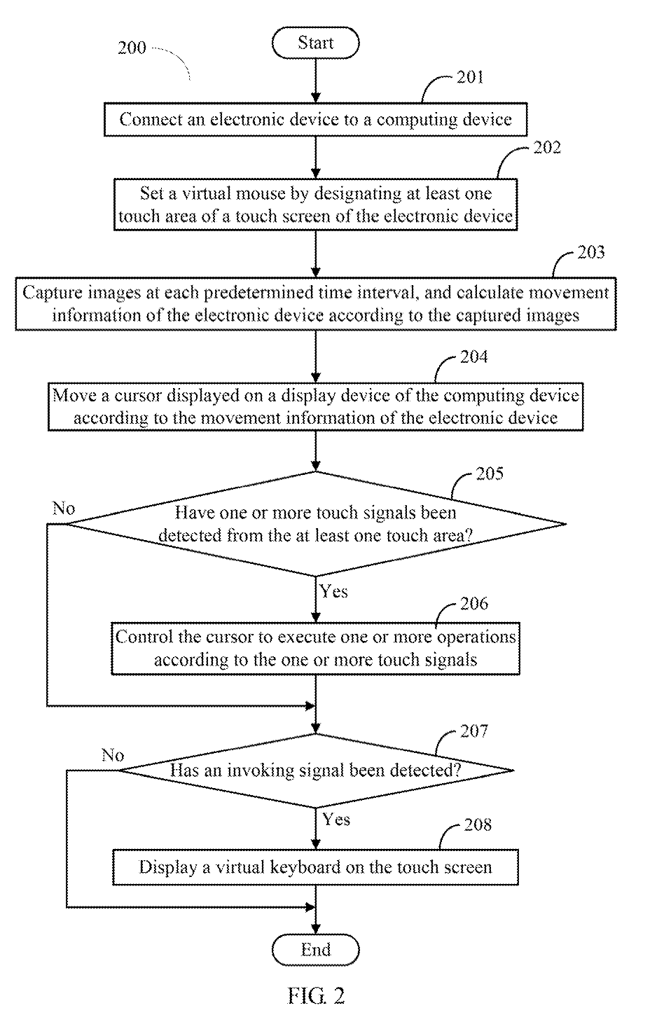

Referring to FIG. 2, a flowchart is presented in accordance with an example embodiment. The example method 200 is provided by way of example, as there are a variety of ways to carry out the method. The example method 200 described below can be carried out using the configurations illustrated in FIG. 1, for example, and various elements of these figures are referenced in explaining example method 200. Each block shown in FIG. 2 represents one or more processes, methods, or subroutines, carried out in the example method 200. Furthermore, the illustrated order of blocks is illustrative only and the order of the blocks can be changed. Additional blocks can be added or fewer blocks may be utilized without departing from this disclosure. The example method 200 can begin at block 201.

At block 201, a connection module connects an electronic device to a computing device through a first wireless device and a second wireless device. In at least one embodiment, the first wireless device and the second wireless device are Bluetooth devices.

At block 202, a setting module sets a virtual mouse by designating at least one touch area of a touch screen through a setting interface. The at least one touch area includes a virtual left mouse button corresponding to a first touch area of the touch screen, a virtual right mouse button corresponding to a second touch area of the touch screen, a virtual mouse wheel corresponding to a third touch area of the touch screen. The setting module also sets a precision of the virtual mouse and a background of the virtual mouse. The precision of the virtual mouse represents a ratio between a movement distance of the electronic device and pixels of the cursor that moves on a display device of the computing device. The movement distance of the electronic device may be pixel distance. For example, when the precision of the virtual mouse is S, it means that the cursor moves S pixels when the electronic device moves per unit pixel (the unit pixel can be 10 pixels, for example). The setting module also displays the virtual mouse on the touch screen.

FIG. 3 is a diagrammatic view of one example embodiment of a setting interface for setting a virtual mouse. In at least one embodiment, the setting interface can be invoked when a predetermined signal is detected on the touch screen. In some embodiments, the predetermined signal can be detected when a predetermined touch operation (e.g. two-finger scroll down) is executed or a preset button (e.g. a virtual button or a physical button) is pressed.

FIG. 4 is a diagrammatic view of one example embodiment of the virtual mouse. The setting module displays the virtual mouse on the touch screen.

At block 203, a calculation module captures images at predetermined time intervals using a camera module, and calculates movement information of the electronic device according to the captured images. In at least one embodiment, the calculation module acquires two consecutive images, which include a first image and a second image, from the captured images. The calculation module further calculates movement information of the electronic device by comparing the first image and the second image.

The calculation module extracts at least one specified feature in both of the first image and the second image, and calculates the movement information of the electronic device by calculating movement information of the specified feature. In some embodiments, the specified feature can be represented by dots in a two-dimensional Cartesian coordinate system as shown in FIG. 5 and FIG. 6. The calculation module calculates the movement information of the specified feature according to changes of coordinates of the specified feature. When the calculation module cannot extract any specified features in both of the first image and the second image, that is, the first image and the second image have no features that are the same, the calculation module indicates a user to move the electronic device to capture new images in a default manner (e.g., outputting an audio prompt or a text prompt).

FIG. 5 is a diagrammatic view of one example embodiment of the first image. FIG. 6 is a diagrammatic view of one example embodiment of the second image. As shown in FIG. 5, when a first image 50 is captured, the calculation module extracts three features (A, B and C). The calculation module also determines coordinates of the three features. When a second image 60 is captured, the calculation module searches the second image 60. As shown in FIG. 6, the calculation module merely finds the features A and B in the second image, and then extracts coordinates of the features A and B. Accordingly, the features A and B are determined to be the specified features which are both in the first image 50 and the second image 60. The calculation module calculates the movement information of the electronic device according to the movement information of the features A and B. In one embodiment, the calculation module also extracts a feature D from the second image 60 to make sure that the calculation module can also search for three features A, B and D in a third image.

In at least one embodiment, the calculation module can calculate the movement information of the electronic device by determining one specified feature that is closest to a center of the first image 50, and calculating the movement information of the specified feature that is closest to the center of the first image 50. FIG. 6 illustrates the features of the first image which can be detected from the second image are feature A and feature B. FIG. 5 illustrates the feature A is the specified feature that is closer to the center of the first image 50. Thus, the calculation module calculates the movement information of the electronic device according to the movement information of the feature A. In at least one embodiment, the calculation module can record the movement information of the electronic device in pixels.

At block 204, a movement module moves a cursor displayed the display device of the computing device according to the movement information of the electronic device. The movement module first determines the movement information of the cursor according to the movement information of the electronic device and the precision of the virtual mouse. Then the movement module moves the cursor displayed on the display device of the computing device according to the movement information of the cursor.

The calculation module can further determine whether the captured images are mirror images. In one embodiment, when the captured images are mirror images, the feature A is moved upwards in X pixels, and moved leftwards in Y pixels, the calculation module determines that the electronic device moves downwards in X pixels, and moves rightwards in Y pixels. And the movement module determines that the cursor moves downwards in X*S pixels, and moves rightwards in Y*S pixels. When the captured images are not mirror images, the feature A is moved upwards in X pixels, and moved leftwards in Y pixels, the calculation module determines that the electronic device moves downwards in X pixels, and moves leftwards in Y pixels. And the movement module determines that the cursor moves downwards in X*S pixels, and moves leftwards in Y*S pixels.

At block 205, a clicking module determines whether one or more touch signals are detected from the at least one touch area of the touch screen. If one or more touch signals are detected from the at least one touch area of the touch screen, block 206 is executed. If no signal is detected from the at least one touch area of the touch screen, block 207 is executed.

At block 206, the clicking module controls the cursor on the display device to execute one or more operations by sending a command to the computing device according to the one or more touch signals. The clicking module determines an operation of a user according to the one or more touch signals, and sends a command to the computing device according to the operation. The operation of the user can be, but is not limited to a left click, a right click, a double left click, a double right click, a scroll up or a scroll down.

At block 207, a input module determines whether a predetermined invoking signal is detected. If the predetermined invoking signal is detected, at block 208, the input module displays a virtual keyboard on the touch screen. If no predetermined invoking signal is detected, process ends. In at least one embodiment, the predetermined invoking signal is triggered when the electronic device rotates more than a preset angle within a time interval. The input module detects a rotated angle using a sensor, and displays a virtual key board on the touch screen when the rotated angle is greater than the preset angle.

Block 203-207 is a loop of the method.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A mouse simulation method being executed by at least one processor of an electronic device, the electronic device comprising a camera module and a touch screen, the electronic device in connection to a computing device, the method comprising:
setting a virtual mouse by designating at least one touch area of the touch screen;
capturing images at predetermined time intervals using the camera module, and acquiring two consecutive images comprising a first image and a second image from the captured images;
calculating movement information of the electronic device by comparing the first image and the second image;
moving a cursor displayed on a display device of the computing device according to the movement information of the electronic device; and
detecting one or more touch signals on the at least one touch area and controlling the cursor on the display device to execute one or more operations according to the one or more touch signals.

2. The method according to claim 1, further comprising:
setting a precision of the virtual mouse; and
moving the cursor on the display device of the computing device according to the movement information of the electronic device and the precision of the virtual mouse.

3. The method according to claim 1, wherein the first image is compared with the second image by:
extracting specified features in both of the first image and the second image, and calculating the movement information of the electronic device by calculating movement information of the specified features.

4. The method according to claim 1, further comprising:
displaying a virtual keyboard on the touch screen in response to detecting a predetermined invoking signal.

5. The method according to claim 1, further comprising:
setting a background of the virtual mouse and displaying the virtual mouse on the touch screen according to the background and the at least one touch area.

6. An electronic device in connection to a computing device, the electronic device comprising:
a camera module;
a touch screen;
at least one processor; and
a storage device that stores one or more programs which, when executed by the at least one processor, causes the at least one processor to:
set a virtual mouse by designating at least one touch area of the touch screen;
capture images at predetermined time intervals using the camera module, and acquire two consecutive images comprising a first image and a second image from the captured images;
calculate movement information of the electronic device by comparing the first image and the second image;
move a cursor displayed on a display device of the computing device according to the movement information of the electronic device; and
detect one or more touch signals on the at least one touch area and control the cursor on the display device to execute one or more operations according to the one or more touch signals.

7. The electronic device according to claim 6, wherein the at least one processor further sets a precision of the virtual mouse, and moves the cursor on the display device of the computing device according to the movement information of the electronic device and the precision of the virtual mouse.

8. The electronic device according to claim 6, wherein the first image is compared with the second image by:
extracting specified features in both of the first image and the second image, and calculating the movement information of the electronic device by calculating movement information of the specified features.

9. The electronic device according to claim 6, wherein the at least one processor further displays a virtual keyboard on the touch screen in response to detecting a predetermined invoking signal.

10. The electronic device according to claim 6, wherein the at least one processor further sets a background of the virtual mouse and displays the virtual mouse on the touch screen according to the background and the at least one touch area.

11. A non-transitory storage medium having shored thereon instruction that, when executed by at least one processor of an electronic device, causes the at least one processor to perform a mouse simulation method, the electronic device comprising a camera module and a touch screen, the electronic device in connection to a computing device, the method comprising:
setting a virtual mouse by designating at least one touch area of the touch screen;
capturing images at predetermined time intervals using the camera module, and acquiring two consecutive images comprising a first image and a second image from the captured images;
calculating movement information of the electronic device by comparing the first image and the second image;
moving a cursor displayed on a display device of the computing device according to the movement information of the electronic device; and
detecting one or more touch signals on the at least one touch area and controlling the cursor on the display device to execute one or more operations according to the one or more touch signals.

12. The non-transitory storage medium according to claim 11, wherein the method further comprises:
setting a precision of the virtual mouse; and
moving the cursor on the display device of the computing device according to the movement information of the electronic device and the precision of the virtual mouse.

13. The non-transitory storage medium according to claim 11, wherein the first image is compared with the second image by:
extracting specified features in both of the first image and the second image, and calculating the movement information of the electronic device by calculating movement information of the specified features.

14. The non-transitory storage medium according to claim 11, wherein the method further comprises:
displaying a virtual keyboard on the touch screen in response to detecting a predetermined invoking signal.

15. The non-transitory storage medium according to claim 11, wherein the method further comprises:
setting a background of the virtual mouse and displaying the virtual mouse on the touch screen according to the background and the at least one touch area.
